(19) United States
(12) Patent Application Publication
(10) Pub. No.: US 2004/0103042 A1
(43) Pub. Date: May 27, 2004

(54) Electronic procurement system

(76) Inventors: Seh M. Ryu, Houston, TX (US); Sung Lee, Houston, TX (US); Kenneth Ryu, Los Gatos, CA (US); Kong M. Chan, Houston, TX (US)

Correspondence Address: NICK A NICHOLS, P O BOX 16399, SUGARLAND, TX, 774966399

(21) Appl. No.: 10/397,553

(22) Filed: Mar. 25, 2003

Related U.S. Application Data
(60) Provisional application No. 60/428,154, filed on Nov. 21, 2002.

(51) Int. Cl. G06F 17/60

(52) U.S. Cl. 705/26

(57) ABSTRACT

A procurement system is disclosed to make a category behave like a specific product that can be chosen and requested through the procurement system. A catalog is easily constructed which: includes all categories of products and services that an organization may procure; inserts specific pertinent products and services that the organization may want to maintain under each category; productizes categories that the organization may allow a user to request; and hides the categories and products that the organization may not allow users in certain positions to view. A procurement system with productized categories accommodates both novice and expert users. Broad product and service requests can be forwarded to designated experts for order assistance. Expert requesters and purchases can refine requests to provide detailed and specific product descriptions.

### CROSS-REFERENCE TO RELATED APPLICATION

This application claims the benefit of U.S. Provisional Application Serial No. 60/428,154, filed Nov. 21, 2002, which application is incorporated herein by reference.

### BACKGROUND OF THE DISCLOSURE

This invention relates to electronic procurement systems, particularly to such systems having the ability to process every expense item in an electronic catalog.

An electronic procurement system allows an organization to purchase a product or service found in an electronic catalog. When an organization has a system that can process every expense item, it can track proposed, committed, and spent expenses as they occur. With such a system an organization is able to control its expenses to be in line with a set budget. Otherwise, the organization must purchase non-catalog items outside of its procurement system and import the expense of the non-catalog item to a system that is used to control expenses against the budget. However, maintaining a product catalog that includes every item that an organization purchases is extremely difficult and costly. New products constantly replace old ones, prices of products change, and new manufacturers and new service organizations emerge replacing those that have been preferred.

When making a purchase via an existing electronic procurement system, users must proceed through a catalog until they find the exact product they want to purchase. Such a system may be convenient to users who have the expertise to choose the proper products. There are however users who would rather have an expert choose suitable products for them. A request from such a user must therefore be forwarded to an expert specializing in the field of the requested product. Some organizations have an extensive support infrastructure with finely divided areas of specialization, while others are only broadly divided. For employees with finely divided areas of specialization, it is desirable for the employee to specify his needs specific enough to find the proper support organization. For others the employee may only be required to specify his needs broadly.

Product categorization systems are commercially available. Electronic Commerce Code Management Association (ECCMA), a non-profit organization, has developed an accepted categorization systems for all products and services, the Universal Standard Products and Services Classification (UNSPSC). The system includes about 10,000 categories. Many of the UNSPSC categories are not pertinent to all organizations and are likely not to be pertinent to all departments and/or divisions within an organization.

Accordingly, it is an object of the present invention to provide a procurement system that contains all products and services that an organization may procure.

It is another object of the present invention to provide a method that allows a procurement system to handle all products and services, yet alleviates the burden of maintaining a catalog.

It is still another object of the present invention to provide a system that accommodates both novice and expert users.

It is another object of the present invention to provide a system that guides the user to specify his needs to enable the system to route the request to an appropriate expert in the field.

It is yet another object of the present invention to display only the categories which are pertinent to an organization and/or the user's position within an organization.

### SUMMARY OF THE INVENTION

In accordance with the present invention, a novel productizing procurement process is disclosed. The procurement process of the invention permits product categories to behave like specific products that may be chosen and requested through a procurement system. Means are provided for creating an electronic procurement solution that addresses problems organizations face when using existing electronic business product catalogs. A product catalog is constructed which: (1) includes all categories of products and services that an organization may procure; (2) specifies products and services that the organization may want to maintain under each category; (3) productizes categories that the organization may allow a user to request; and (4) hides categories and products which the organization may not want users of the procurement system to view.

The terms “productizes categories,” “productizing categories,” “productizing process,” “productize,” “productizing,” and “productized” are meant to encompass application of the productizing rules of the invention to one or more product sets and/or product and service categories in an electronic procurement system.

### BRIEF DESCRIPTION OF THE DRAWINGS

So that the above recited features, advantages and objects of the present invention can be understood in detail, a more particular description of the invention briefly summarized above, may be had by reference to the embodiments thereof which are illustrated in the appended drawings.

It is noted, however, that the appended drawings illustrate only typical embodiments of this invention and are therefore not to be considered limiting of its scope, for the invention may admit to other equally effective embodiments.

FIG. 1 is a diagram of an interface display screen illustrating a product set in accordance with a preferred embodiment of the invention;

FIG. 2 is a diagram of an interface display screen illustrating the product and service categories of a product set selected in accordance with a preferred embodiment of the invention;

FIG. 3a is a diagram of an interface display screen illustrating Rule 1 of the procurement process in accordance with a preferred embodiment of the invention;

FIG. 3b is a diagram of an interface display screen illustrating Rule 1 of the procurement process after a user has made a selection in response to a prompt in accordance with a preferred embodiment of the invention;

FIG. 4a is a diagram of an interface display screen illustrating Rule 2 of the procurement process in accordance with a preferred embodiment of the invention;

FIG. 4b is a diagram of an interface display screen illustrating Rule 2-1 of the procurement process in accordance with a preferred embodiment of the invention;

FIG. 4c is a diagram of an interface display screen illustrating Rule 2-2 of the procurement process in accordance with a preferred embodiment of the invention;

FIG. 4d is a diagram of an interface display screen illustrating the productized product and service categories of a product set in accordance with the productizing rules of the invention shown in FIG. 4c;

FIG. 5a is a diagram of an interface display screen illustrating a user's selections for a product category in accordance with a preferred embodiment of the invention;

FIG. 5b is a diagram of an interface display screen illustrating the productized product and service categories of the product set in accordance with the productizing rules of the invention shown in FIG. 5a;

FIG. 6a is a diagram of an interface display screen illustrating a user's selections for a product category in accordance with a preferred embodiment of the invention;

FIG. 6b is a diagram of an interface display screen illustrating the productized product and service categories of the product set in accordance with the productizing rules of the invention shown in FIG. 6a;

FIG. 7a is a diagram of an interface display screen illustrating a user's selections for a product category in accordance with a preferred embodiment of the invention;

FIG. 7b is a diagram of an interface display screen illustrating the productized product and service categories of the product set in accordance with the productizing rules of the invention shown in FIG. 7a;

FIG. 8a is a diagram of an interface display screen illustrating a user's selections for a product category in accordance with a preferred embodiment of the invention;

FIG. 8b is a diagram of an interface display screen illustrating the productized product and service categories of the product set in accordance with the productizing rules of the invention shown in FIG. 8a;

FIG. 9a is a diagram of an interface display screen illustrating a user's selections for a product category in accordance with a preferred embodiment of the invention;

FIG. 9b is a diagram of an interface display screen illustrating the productized product and service categories of the product set in accordance with the productizing rules of the invention shown in FIG. 9a;

FIG. 10 is a diagram of a summarization interface display screen in accordance with a preferred embodiment of the invention; and

FIGS. 11a-11d are diagrams illustrating user interface display screens for ordering goods and services in a UNSPSC Catalog in accordance with a preferred embodiment of the invention;

### DESCRIPTION OF A PREFERRED EMBODIMENT

The present invention offers organizations the ability to set rules governing productizing categories of its procurement system, control access to categories based on user access authority, regardless of whether the category is productized or not productized, and identify orderable categories by marking them with an identifying symbol.

The invention of the present disclosure utilizes the tree user interface concept disclosed in Applicant's co-pending U.S. application Ser. No. 10/073,431, filed Feb. 11, 2002, which is incorporated by reference herein in its entirety.

The tree user interface concept can be best explained by reference to a genealogy or family tree. A typical family tree starts off with the parents and proceeds downward to the children and then to the grandchildren. The tree may proceed even further to the great grandchildren, and downward to their children. The Applicant's prior patent application discloses a process of assigning decision values to any member on the tree. When the decision value applied to a member is different from that of its parents, the member is referred to as a rebel. The rebel member's traits pass down the tree to all descendants of the rebel member until a new decision value is applied to a descendant and a new rebel member is created.

In the present invention however, productizing rules are applied to a member of a product category instead of decision values. The rules applied to rebel members are referred to as the rebel rules. Rules may be applied to any member categories in the product set to tag thousands of categories with either a single or multiple sets of rules.

Productizing categories in accordance with the invention makes it possible for an electronic procurement solution to handle every expense item within an organization's product procurement catalog. In existing procurement systems if a user wants to order a product or service, i.e. catering services for example, which are not found in an organization's catalog as an itemized product or service, he would need to make the request outside of the organization's catalog using a user interface system dedicated to handling non-catalog items. Utilizing the product procurement system of the invention, however, a user no longer needs to leave the organization's catalog since all categories of products and services available for a user to request are included in the organization's catalog.

Handling every expense item in the same system enables the procurement system of the invention to be tied directly to budgeting. Productizing categories allows users to propose expenditures to determine how such expenditures will affect a specific budget item before actually submitting the product request. The budget item may be as broad as “travel and entertainment” or as specific or granular as “travel lodging.” The following example illustrates the application of this feature of the invention.

Assume that an expenditure of $1,000 is proposed for a sales trip. The requestor's supervisor receives the expenditure request and decides whether to approve or reject the expenditure. Since the expense items are tied directly to budget items, the supervisor instantly determines travel expenditures to date, travel expenditures approved but not yet spent, and the balance remaining in the travel budget. The supervisor may then make a decision on the proposed expenditure viewing the impact of the expenditure on the travel budget on a real-time basis. The ability to approve or reject expenditures based on real-time information is instrumental to an organization meeting its budget goals.

Other benefits of tying an organization's procurement system directly to budget goals are readily apparent. If, for example, the supervisor determines that the sales trip is important, she may propose a reallocation of the budget to accommodate the increased expense. The supervisor may then forward the proposed travel budget increase to her supervisor or department head for approval. The department head reviews how the proposed travel budget increase will affect the department budget as a whole by viewing the real-time information on spent, committed, and uncommitted funds. This feature of the invention enables organizations to take a proactive approach to budget controls.

In addition, since each purchase through a productized category ties to a specific general ledger account segment, a procurement system adopting the productizing categories method of the invention can feed information directly to the general ledger system. This obviates manual posting of expenses to the general ledger account, and reduces auditing of the financial statements.

Using an electronic procurement system that employs the productizing categories concept of the invention removes the need for an organization to create, maintain, and update voluminous catalogs of products and services. An organization is not required to conduct the costly process of creating a catalog, since productizing categories makes it easy to tailor existing catalogs.

In most cases, well-established searchable catalogs are available for certain product categories such as Information Technology and Office Supplies. Other catalogs, like the UNSPSC, are also available free of charge to the public. If an organization utilizes an existing catalog in a procurement system that does not productize categories, users of the organization's procurement system must search through a large database of products, many of which may be irrelevant to the organization's business to locate the desired product. The invention of the present disclosure enables an organization to hide product and service categories that do not pertain to its business.

The procurement system of the invention not only makes it easy to tailor a company-wide procurement catalog, it also makes it easy to tailor a catalog that meets the specific purchasing requirements of different departments within an organization sharing a master catalog. For example, the legal department's access to the organization's procurement system catalog may hide building maintenance items, while the building maintenance department is provided access to specific building maintenance items such as road repair, roof repair, air condition services, plumbing services, electric services and the like, but not to legal services categories. Tailoring catalogs by limiting access to different decision levels saves the requester the time of searching through irrelevant categories, and saves the organization money associated with improper purchases.

Productizing categories also enables a user to order a product by broad category. For example, a user with no IT experience may request a computer and simply attach a note to the request describing what the computer is to be used for. An experienced IT professional may order a computer with exact specifications. A requestor that neither knows nor prefers a brand, or features, can save time by requesting a product based on category, rather than researching products suitable for the intended purpose. Such a requestor may simply choose a productized category such as “notebook computer” and request it with a note attached, such as “mainly used for writing.”

Productizing categories enables the user to make a product request, such as a notebook computer, and route it to an expert in the computer field within the organization. The request is automatically routed to the appropriate expert to review the request and add further specifications. This saves the organization money by purchasing a computer that meets the individual's needs and saves the requestor's time associated with finding the expert. Each participant in the procurement process may define and redefine the product request to make the request more specific as it is routed through the procurement system. At each step, each person processing the request can modify and better define the product request as needed. For example, the computer expert may convert the request for a notebook computer to an Intel Pentium III 850 Mhz product. The organization's buyer may convert it again to a specific product, such as an IBM notebook 2648R1U to order with a vendor.

Since a “product” request may be a category and not a specific item, an electronic procurement system using productizing categories allows users to utilize the system for more than just ordering a product. A user may attach a document with a quote or proposal for a specific product pertaining to the category. In addition, the user may define a specific product model number if that is available. The user may also simply request a dollar budget approval amount in which the exact product and service is defined at a later time.

Referring now to FIG. 1, use of the electronic procurement system of the present invention begins with a user interface tool identified as the product set. It is understood that the present invention provides system software architecture for implementing the present invention. The electronic procurement system of the invention may be implemented on a computer system having typical computer components such as a processor, memory, storage devices, keyboard, display, etc. Input data is received by the procurement system from an input device, such as keyboard, and information is provided to a user via a display.

Referring still to FIG. 1, the product set user interface display screen is where a product procurement administrator may customize product catalogs for his organization and individual departments. FIG. 1 is an example of a preferred embodiment of product set templates of the invention. The administrator may create a new product set by clicking on the “create new template” button on the bottom right-hand corner of FIG. 1. By clicking on the “create new template” button, the administrator may create and name a new product set. The name may identify which department will use the catalog. The administrator then selects the catalog to be customized. The catalog may be a standard IT catalog, a UNSPSC catalog, or any other catalog that is utilized by the organization.

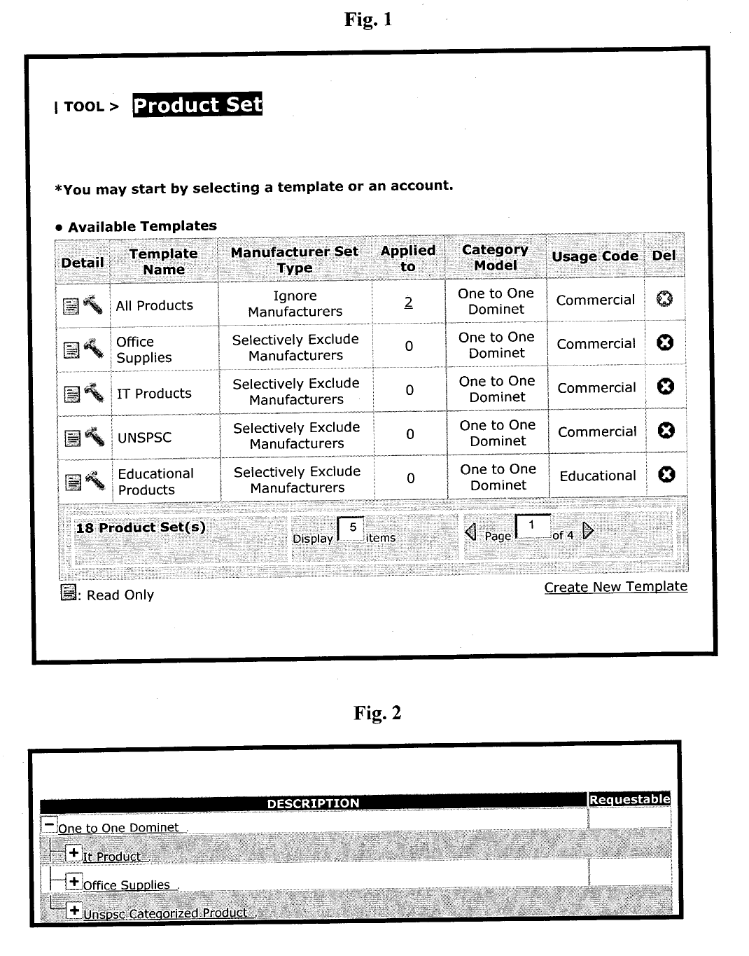

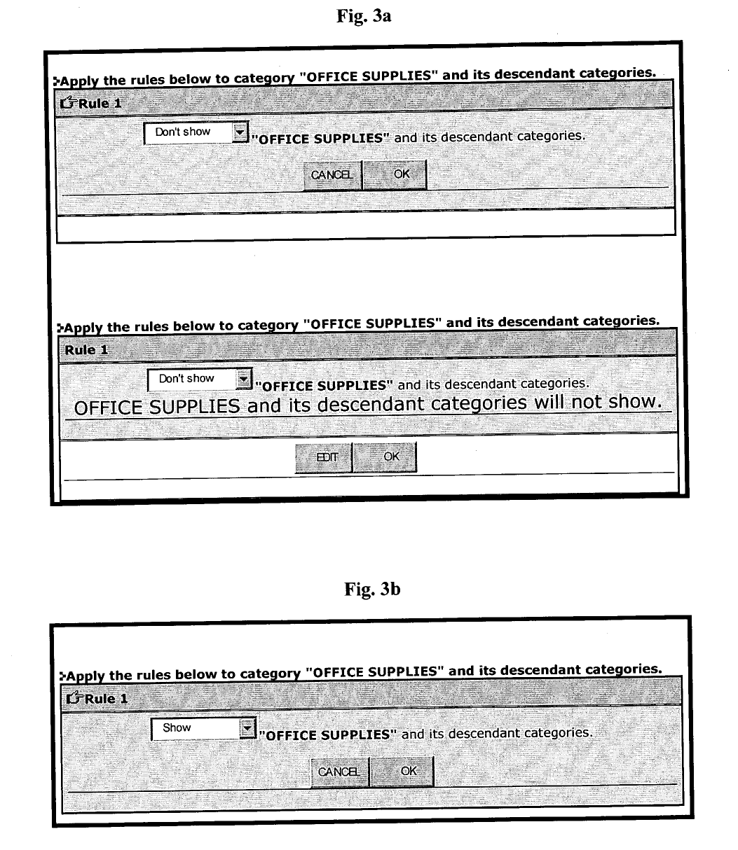

FIG. 2 illustrates a preferred embodiment of a user interface display screen for applying the invention to a catalog. The administrator begins by selecting the category to be tailored to the requirements of the organization. In the following example, the administrator selects the OFFICE SUPPLIES category to begin the productizing process and is directed to the next user interface display screen (FIG. 3a), where he is prompted to set the productizing rules. FIG. 3a illustrates Rule 1 of the productizing categories process. Rule 1 gives the administrator the option to either “show” or “don't show” the OFFICE SUPPLIES category and its descendent categories. If the administrator chooses “don't show,” as is illustrated in FIG. 3a, the OFFICE SUPPLIES category will not be viewable by the intended users of the catalog and they will not be able to purchase any products from the OFFICE SUPPLIES category.

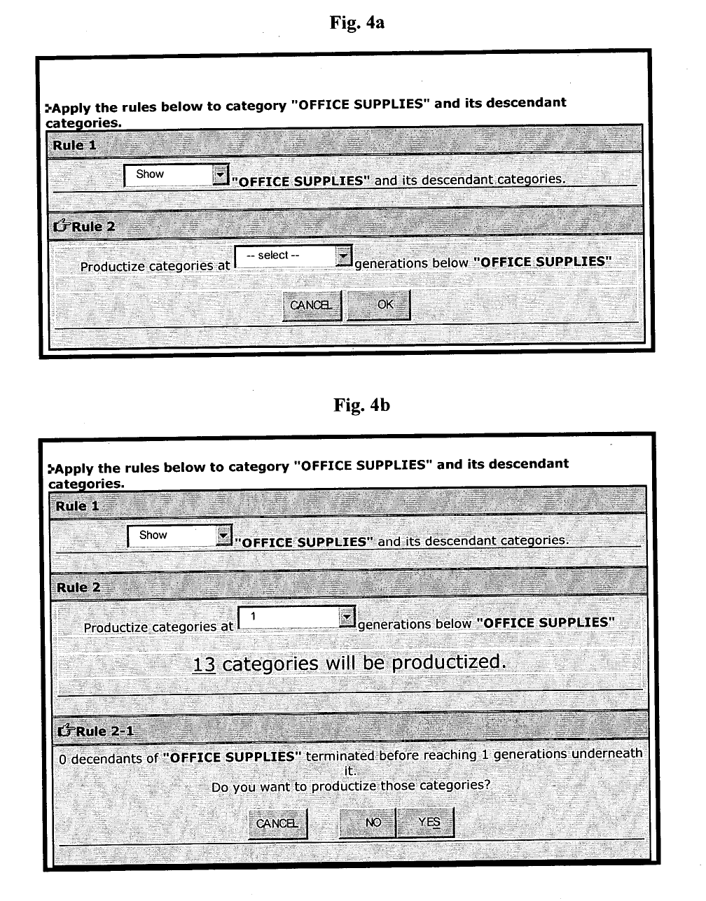

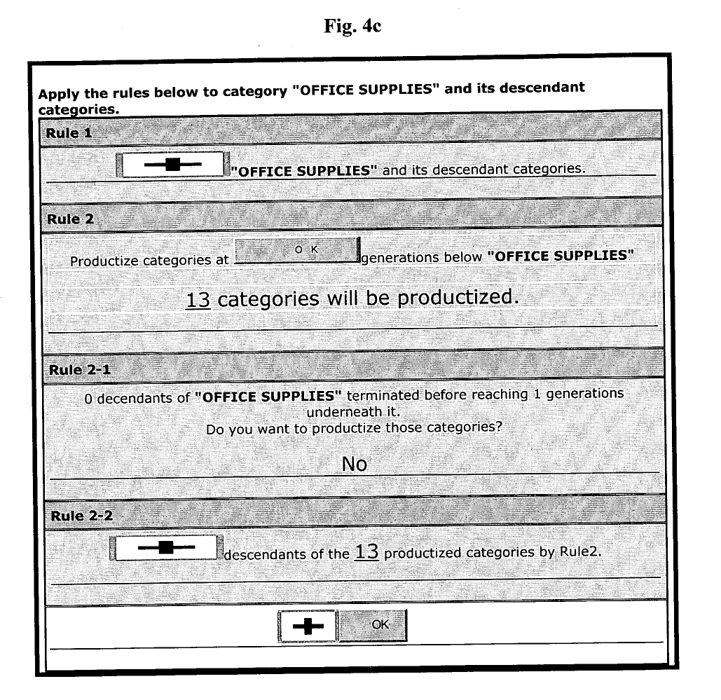

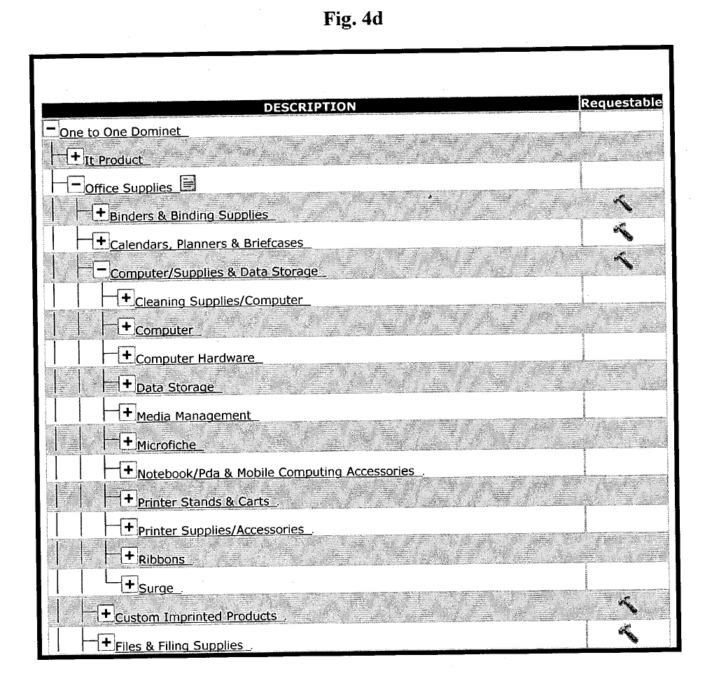

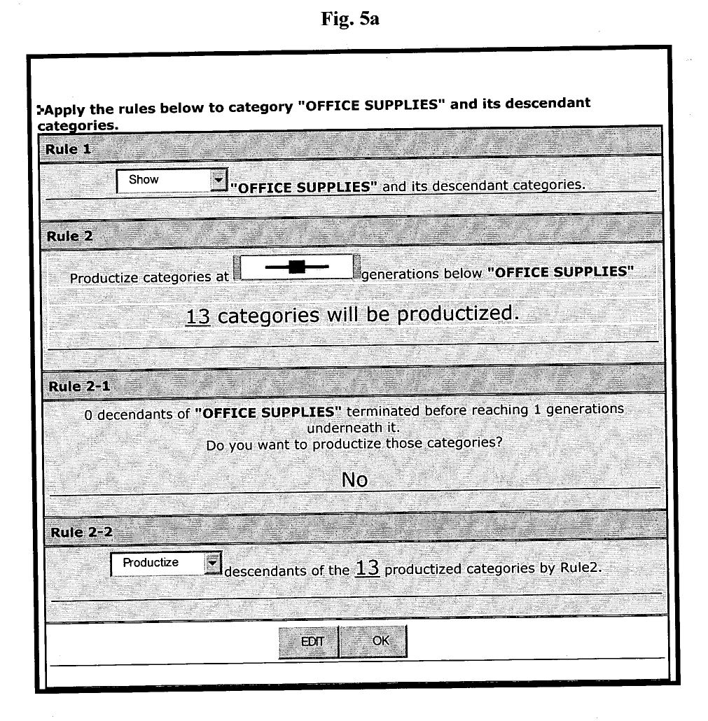

By choosing “show” the OFFICE SUPPLIES category, as illustrated in FIG. 3b, and clicking on the “OK” button, the administrator advances to Rule 2 of the productizing categories process. Rule 2 is illustrated in FIG. 4a where the administrator is given the choice of how many generations or subcategories of the OFFICE SUPPLIES category he wishes to productive. The administrator may choose to productize as many subcategories as are beneath the original category.

In the present example, the administrator elects to productize “1-generation” below the OFFICE SUPPLIES category and clicks the “OK” button. On the next user interface display screen illustrated in FIG. 4b, the administrator is prompted that 13 categories at the “1-generation” level below OFFICE SUPPLIES will be productized and is further prompted to answer Rule 2-1 of the productizing concept. Rule 2-1 enables the administrator to productive those categories that did not reach the “1-generation” level below the selected category, which will be described in greater detail later herein. In the example of FIG. 4b, there are no categories that ended before reaching the “1-generation” level below the OFFICE SUPPLIES category. After selecting “NO” to the Rule 2-1 prompt, the administrator is directed to the next user interface display screen.

Referring now to FIG. 4c, Rule 2-2 of the productizing process of the invention is illustrated. At this point, the administrator is asked whether to productive the descendants of those categories that were productized with Rule 2 above. The administrator is given two options, either “productize” or “don't show” the descendants of the productized categories. For this example, the administrator chose not to productize the descendants of the 13 productized categories at the “1-generation” level below the OFFICE SUPPLIES category found by Rule 2. After making his choice, the administrator clicks on the “OK” button to save the productizing rules.

After saving the productizing rules, the administrator may view the catalog with the rules in place. FIG. 4d illustrates the product catalog following the rules set above. All categories “1-generation” below the OFFICE SUPPLIES category were productized. A symbol, i.e. hammer, next to the productized categories confirms that the rules set by the administrator were accepted. All productized categories “1-generation” below OFFICE SUPPLIES, for example BINDERS & BINDING SUPPLIES and COMPUTER/SUPPLIES & DATA STORAGE are marked with a hammer symbol next to them. However, it will be noted that the descendant “children” of the “1-generation” level categories, i.e. Cleaning Supplies/Computer, Computer, etc. categories, do not show a hammer symbol next to them, because the administrator elected not to productize descendant children more than “1-generation” below the original OFFICE SUPPLIES category when prompted by Rule 2-2 above. The intended users of the catalog will therefore not be permitted to access categories below the categories marked with a hammer symbol. Only the categories marked with the hammer symbol have been productized and therefore product requests are limited to that level.

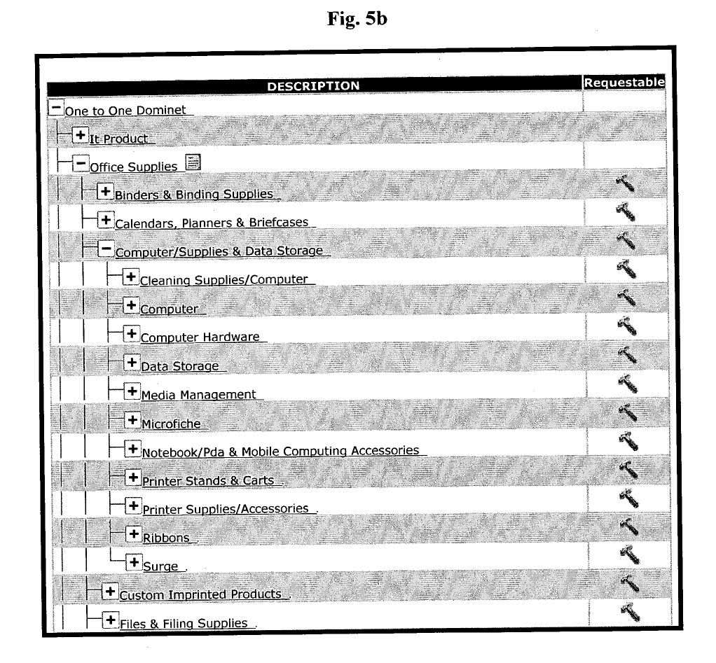

In the event the administrator wants to set new productizing rules to the OFFICE SUPPLIES category, he would follow the same process as described above. The following discussion illustrates how applying different productizing rules affect the catalog that the intended user will see. In the following example, the administrator will again productize “1-generation” below OFFICE SUPPLIES, but when prompted in Rule 2-2 whether to productize descendant children categories, the administrator chooses to productive the descendants of the productized categories. FIG. 5a illustrates that the above rules have been selected. Clicking on the “OK” button accepts the rules and the administrator proceeds to a new catalog description page illustrated in FIG. 5b. FIG. 5b appears similar to FIG. 4d above, except that the descendant categories of the “1-generation” category COMPUTER/SUPPLIES & DATA STORAGE now also have a hammer symbol next to them indicating that they have been productized. The intended user may therefore proceed to this level in the procurement system before making a product request. However, the user still has the option to make a product request at the broader “1-generation” level COMPUTER/SUPPLIES & DATA STORAGE category.

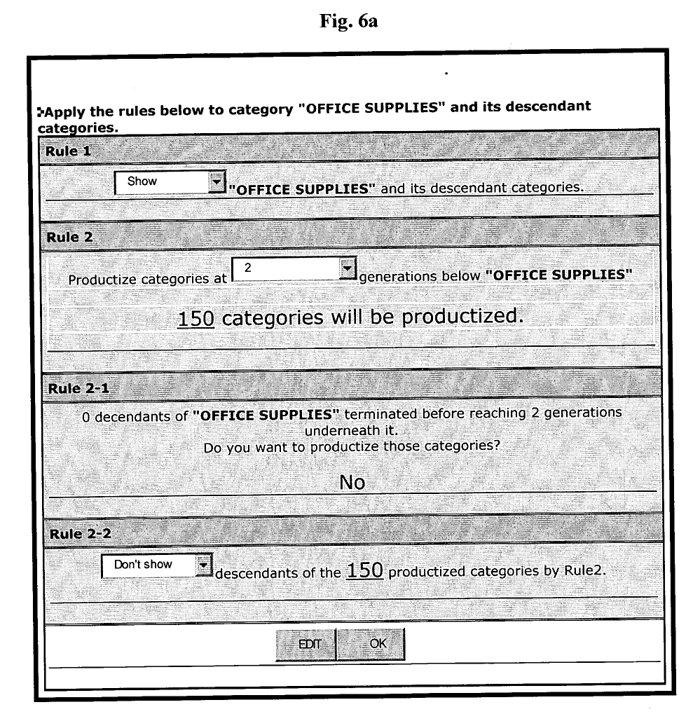

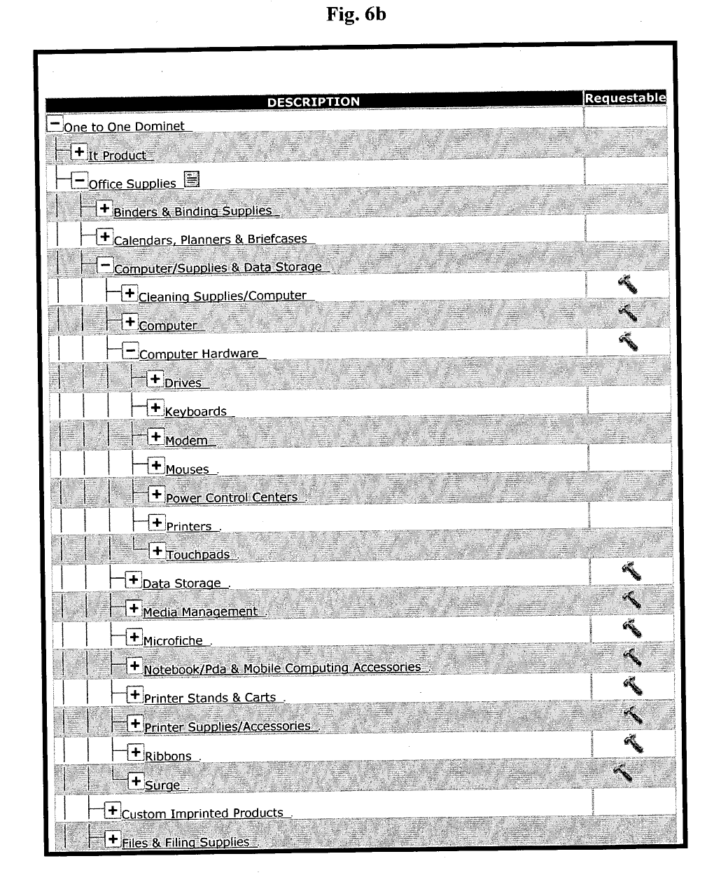

Referring now to FIG. 6a, the effect of productizing “2-generations” below a selected category in Rule 2 and “None” of the descendants of the productized categories under Rule 2-2 is illustrated. FIG. 6a illustrates the choices made by the administrator. Upon clicking the “OK” button, the administrator is directed to a new user interface screen illustrated in FIG. 6b. It will be observed that in FIG. 6b only the categories found “2-generations” below OFFICE SUPPLIES, i.e. the grandchildren categories under OFFICE SUPPLIES, are marked with a hammer symbol next to them. The end user must therefore proceed to the “2-generation” level of categories before submitting a product request. For example, the end user may submit a request at the CLEANING SUPPLIES/COMPUTER category, but not at the broader “1-generation” level COMPUTER/SUPPLIES & DATA STORAGE category. The administrator may set the rules illustrated in FIGS. 6a and 6b to provide greater access to the product catalog for a department having greater knowledge of the Office Supply category.

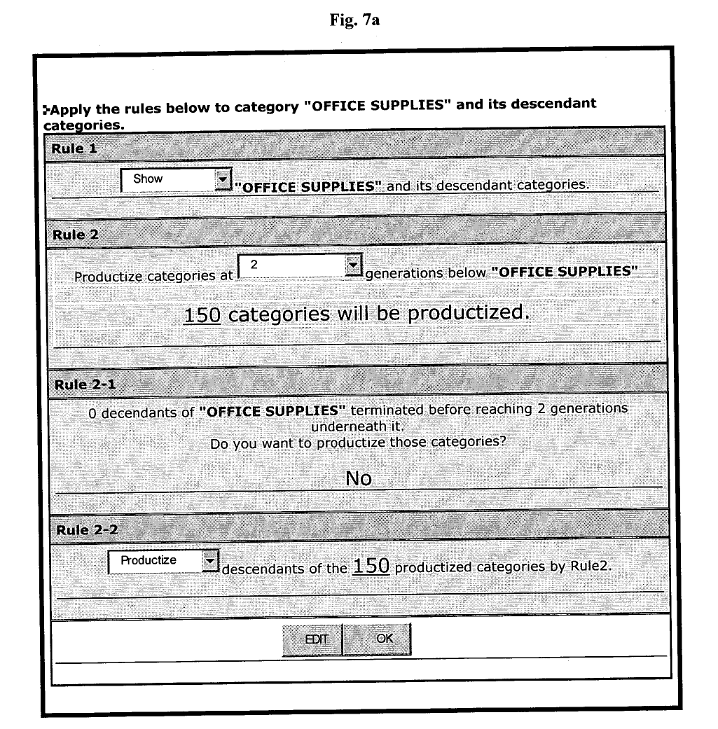

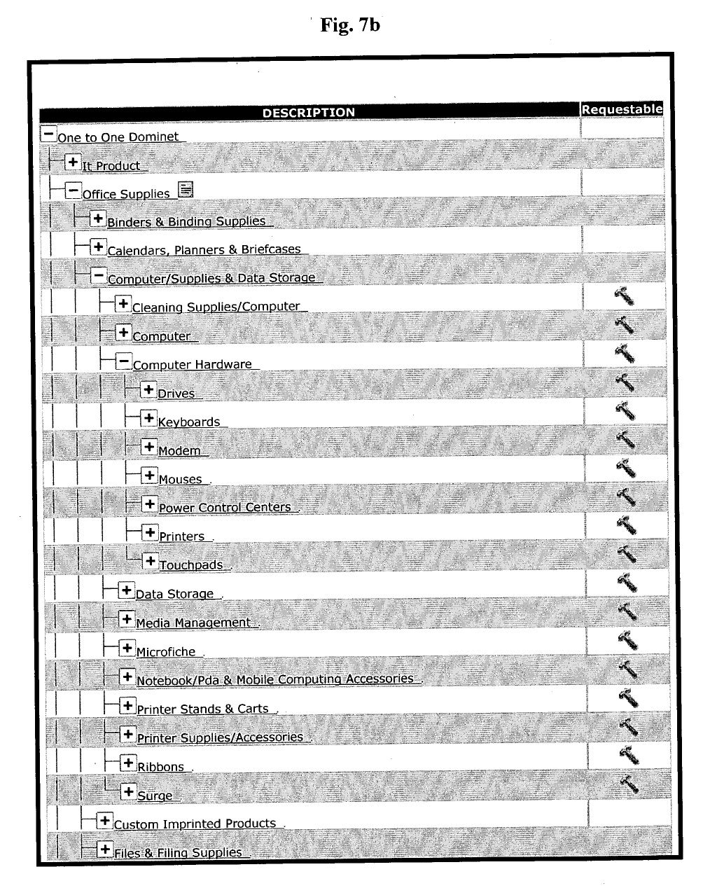

Another variation of the productizing rules is illustrated in FIG. 7a wherein the administrator again chose to productize “2-generations” below the OFFICE SUPPLIES category. However, in this example, the administrator also chose to productize the descendant children of the “2-generations” categories productized under Rule 2. That is, the descendant grandchildren and descendant great-grandchildren under the OFFICE SUPPLIES category are productized. FIG. 7b illustrates the results on the product catalog of accepting the above rules. Both the descendant children and the descendant grandchildren categories of the COMPUTER/SUPPLIES & DATA STORAGE category, i.e. COMPUTER HARDWARE, DRIVER, etc. categories, are marked with a hammer symbol and may be accessed for ordering a product.

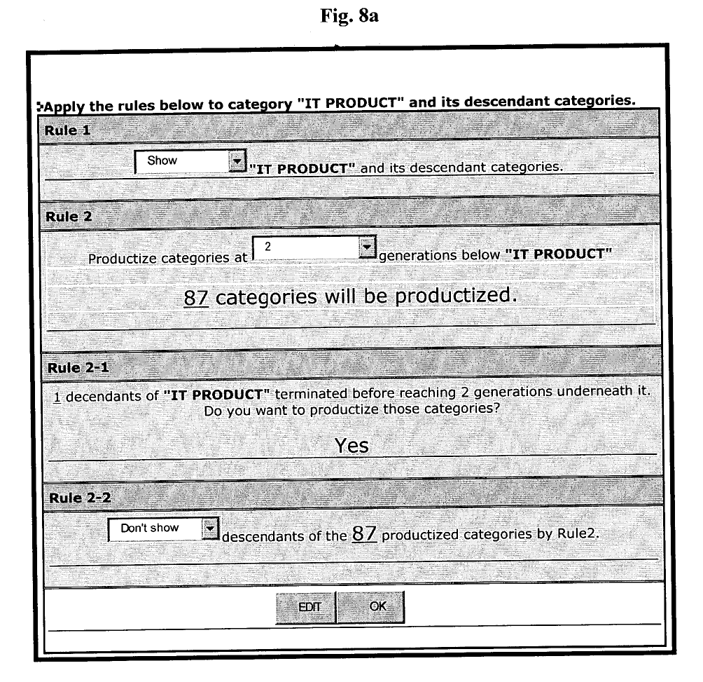

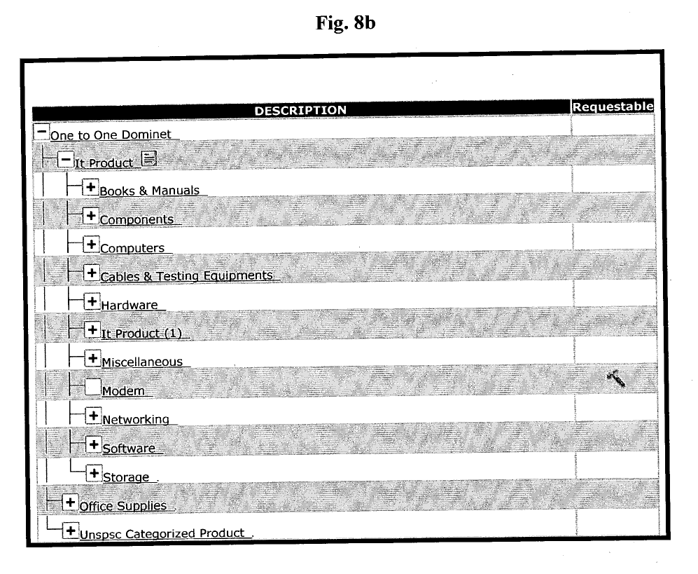

In the above examples no categories ended before reaching the selected generations under Rule 2. As a result, the effect of choosing “YES” to productize categories that did not reach the selected generation level under Rule 2-1 has not been examined. In the following example, the effect of Rule 2-1 is illustrated. Referring specifically to FIG. 8a, the administrator has chosen to productize “2-generations” below the IT PRODUCT category. After making the selection, the administrator is prompted that one descendant category terminated before reaching the selected generation level. Termination of a category before reaching a selected generation level indicates that the category does not have descendant categories at the selected level. If the terminating category is to be productized, the administrator must select “YES” to the Rule 2-1 prompt, which is illustrated in FIG. 8a. FIG. 8b shows the results of the rules established by the administrator. The category that did not reach the “2-generations” level is the Modem category. In accordance with the rules established by the administrator, the Modem category is productized, marked with a hammer symbol, and may be requested at this level. If the administrator had selected “NO” under Rule 2-2, the intended user of the product catalog would not have the option of requesting a product from the Modem category level because it would not have been productized. It will also be observed that the administrator elected under Rule 2-2 not to productive the descendants of the productized categories under Rule 2. Thus at the “2-generation” level only the Modem category is productized as shown in FIG. 8b.

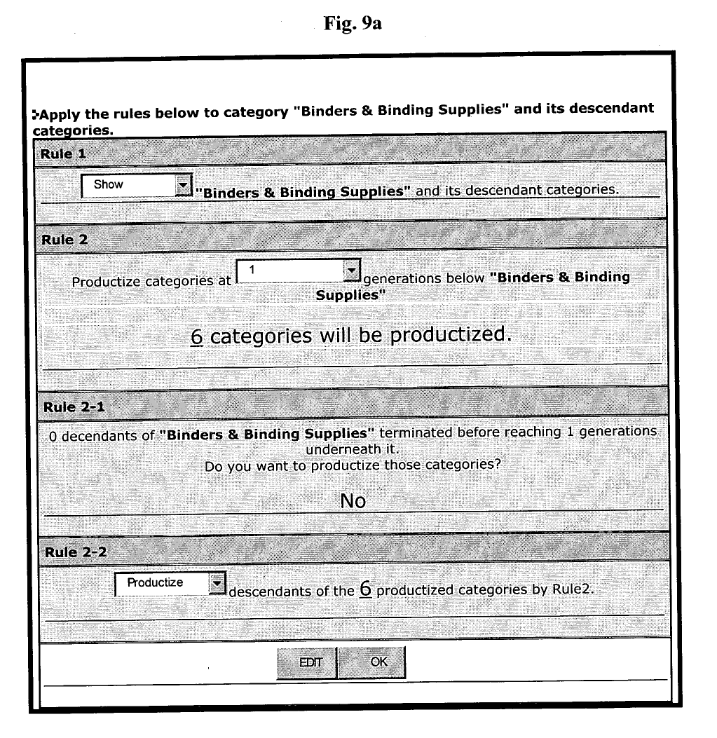

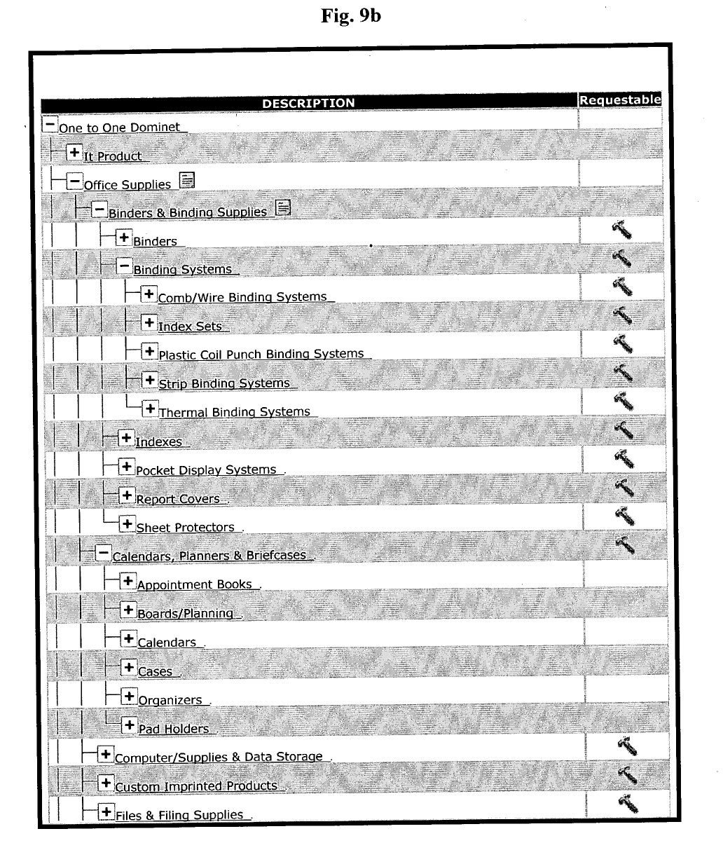

Upon completing setting the rules for one or more categories, the administrator still has the option of setting “rebel” rules to the catalog. Rebel rules are more fully discussed in Applicant's co-pending U.S. application Ser. No. 10/073,431, filed Feb. 11, 2002, which is incorporated by reference herein in its entirety. For example, the administrator may assign rebel productizing rules to any subcategory under OFFICE SUPPLIES. Assuming the administrator sets the same productizing rules for the OFFICE SUPPLIES category illustrated in FIGS. 4a-4d (1 generation below/no children), he has the option of setting different productizing rules for the subcategories. FIG. 9a illustrates the different rules set for the BINDERS & BINDING SUPPLIES subcategory. Since the administrator elected to productize descendants under Rule 2-2, it will be observed that the descendant children of the BINDERS & BINDING SUPPLIES subcategory are marked with the hammer symbol, shown in FIG. 9b. However, the descendant children of the other subcategories, i.e. Appointment Books under the Calendars, Planners & Briefcases subcategory for example, do not have a hammer symbol by them since they were not assigned rebel productizing rules. The organization thus has the flexibility to tailor purchasing choices to meet their specific procurement needs without creating an entirely new catalog.

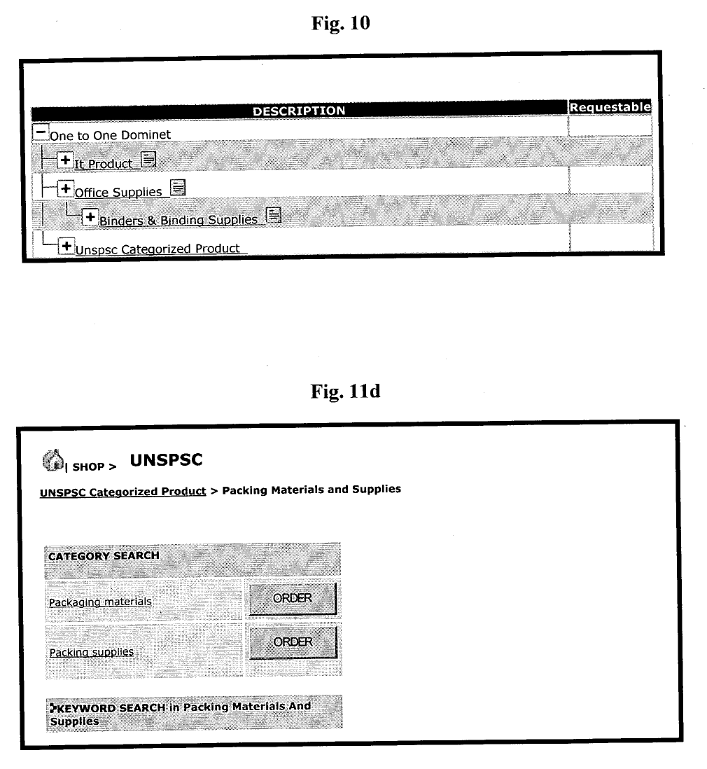

After the productizing rules for the catalog have been entered, the administrator may summarize the results. Summarization displays those categories that have the productizing rules attached to them. As illustrated in FIG. 10, when the administrator invokes summarization an icon next to a category indicates that productizing rules are set for the marked category. It will be observed that the summarization display screen in FIG. 10 shows that the IT PRODUCTS, OFFICE SUPPLIES, and BINDERS & BINDING SUPPLIES categories discussed above have the productizing rules of the invention applied to them. This makes it convenient for the administrator to view where the rebel rules exist and to make changes as may be required to update and maintain the procurement system of the organization.

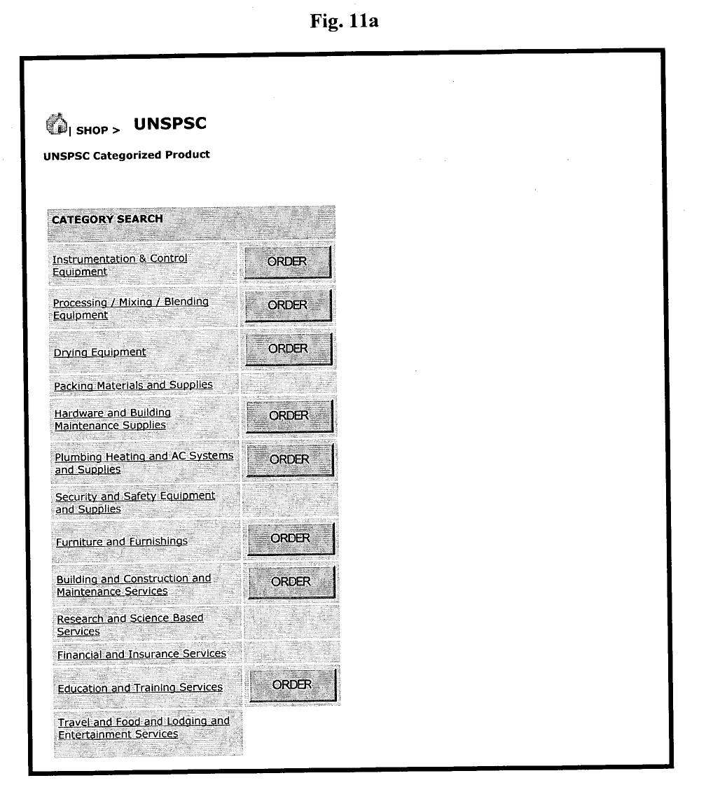

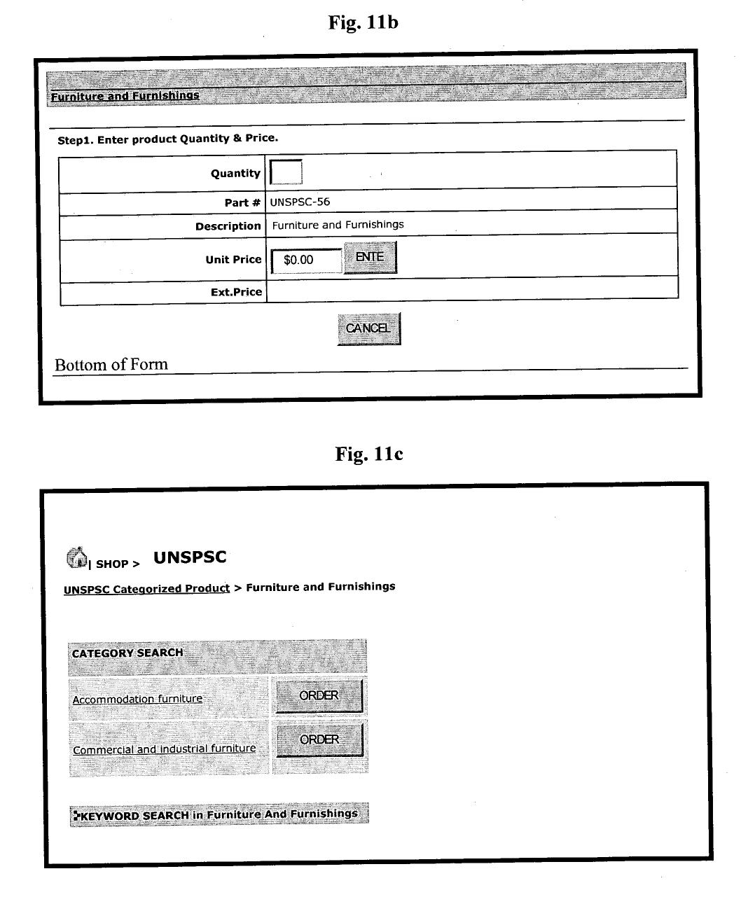

Use of the procurement system of the invention is simple and intuitive. First, the end-user chooses the appropriate product catalog after logging in to the electronic procurement system. In the following example shown in FIGS. 11a-11d, the user chose the UNSPSC Catalog (FIG. 11a). The procurement system reveals the available categories of products/services for the UNSPSC Catalog. An “ORDER” button appears to the right of the items productized at the first generation to indicate that an order may be placed without narrowing the search through additional subcategories. After selecting “ORDER”, the procurement system transfers the end-user to another interface screen where the appropriate Quantity and Price, and description of the product may be chosen (FIG. 11b).

The end-user may narrow the search further by clicking on a category instead of the “ORDER” button. Clicking on a category reveals more specific subcategories under the selected category. For example, clicking on the category Furniture and Furnishings in FIG. 11a directs the user to the interface display screen shown in 11c, which displays the subcategories under the selected category. Depending on the end-user's expertise level, he may initiate an order by clicking on the “ORDER” button or refine the search further. Users of the procurement system of the invention may therefore order items based on their expertise level.

Referring again to FIG. 11a, categories without an “ORDER” button displayed next to them were productized at the “2-generations” level and require a narrower search. FIG. 11a indicates that the “ORDER” button is not available for the Packing Materials and Supplies category. The user must therefore click on the category name to narrow the search. The narrower search reveals two subcategories: “Packing Materials” and “Packing Supplies” (FIG. 11d). At this point, the user may end his search by clicking on the “ORDER” button or refine the search further by clicking on a subcategory name.

While a preferred embodiment of the invention has been shown and described, other and further embodiments of the invention may be devised without departing from the basic scope thereof, and the scope thereof is determined by the claims which follow.

1. A procurement system that handles categories of products and services as if they were product items in a catalog, which can be selected and requested.

2. The system of claim 1, including a user interface that an administrator of the procurement system would use to selectively define and store rules that determine which categories in the catalog can be requested as if they were products.

3. The system of claim 2, wherein said user interface stores rules, which apply to descendant's categories.

4. The system of claim 3, wherein said user interface stores rules, which apply to the children of the descendant categories.

5. The system of claim 4, wherein a rule applied to a descendant rebel overrides the rule applied to its direct ancestor member.

6. The system of claim 5, wherein said user interface applies the rules to allow only the rebels and direct ancestors of the rebels to be seen when the administrator invokes summarization.

7. The system of claim 6, wherein the rules include: show or do not show the descendants; make x generation descendants rebels; make descendants that do not reach x generations products; either productize or do not show the children of a product.

8. The system of claim 1, wherein the categories are adopted from the UNSPSC categorization system.

9. The system of claim 1, wherein said user interface that accommodates both novice and expert users by allowing both broad and granular requests.

10. The system of claim 1, wherein productized categories can be routed to designated experts in the appropriate field.

11. The system of claim 1, wherein said user interface assigns the products to a general ledger account segment and budget item.

12. The system of claim 9, wherein a procurement request amount for a product or service is applied to proposed expenses in the general ledger account segment and budget items.

13. The system of claim 10, wherein the approved procurement amount is applied to the general ledger account segment and budget items as committed.

14. The system of claim 11, wherein the amount paid against procurement is applied to the general ledger account segment and budget items as spent.

15. The system of claim 12, wherein said user interface is used to control expenses.

16. The system of claim 1 including a user interface for selectively defining and storing rules for determining the depth of categories in a catalog that a user may access before making a product request.

17. A computer implemented method for assisting a user in using a procurement system comprising the steps of: providing a user interface for storing rules applied to product and service categories; querying the user regarding available actions; and applying said rules to said categories in response to user input.
